(19) United States
(12) Patent Application Publication
(10) Pub. No.: US 2024/0107313 A1
(43) Pub. Date: Mar. 28, 2024

(54) CONTROL FRAME PROCESSING METHOD, CONTROL FRAME GENERATING METHOD, STATION, ACCESS POINT, AND STORAGE MEDIUM

(71) Applicant: ESPRESSIF SYSTEMS (SHANGHAI) CO., LTD., Shanghai (CN)

(72) Inventors: YUANYUAN ZHANG, SHANGHAI (CN); SHENGDONG GU, SHANGHAI (CN); JUNYI ZHANG, SHANGHAI (CN)

(21) Appl. No.: 18/260,211

(22) PCT Filed: Dec. 31, 2021
(86) PCT No.: PCT/CN2021/143958

§ 371 Date: Jun. 30, 2023

(30) Foreign Application Priority Data
Dec. 31, 2020 (CN) 202011643629.X

(51) Int. Cl. H04W 12/106; H04W 12/037; H04W 12/122

(52) U.S. Cl. CPC H04W 12/106; H04W 12/037; H04W 12/122; H04W 84/12

(57) ABSTRACT

A control frame processing method receives a control frame transmitted by the access point, and parses the received control frame to extract a random value and a MIC check value therein; decrypts the random value and the MIC check value by using a data key from the access point to obtain an original plaintext of the random value and the original plaintext of the MIC check value; calculates a local MIC check value using the MIC key from the access point, the non-check field in the control frame, and the random value; determines whether the original plaintext of the MIC check value is consistent with the local MIC check value, and in response to that the original plaintext of the MIC check value is consistent with the local MIC check value, performs a corresponding control operation according to the control frame.

### CROSS-REFERENCE TO RELATED APPLICATIONS

This application is the U.S. National Phase Application under 35 U.S.C. § 371 of International Patent Application No. PCT/CN2021/143958 filed on Dec. 31, 2021, which claims priority to Chinese Patent Application CN202011643629.X filed on Dec. 31, 2020. The disclosures of the aforementioned applications are hereby incorporated by reference in their entireties.

### TECHNICAL FIELD

The present application relates to the technical field of wireless communication, and in particular to a control frame processing method, a station, a control frame generating method, an access point, and a computer-readable storage medium.

### BACKGROUND ART

With the increasing popularity of personal electronic devices such as mobile phones and PADs, and the in-depth development of Internet of Things technology, the number of devices with Wi-Fi communication needs is growing explosively. In high-density deployment scenarios, the transmission efficiency of Wi-Fi becomes one of the keys that affect user experience. Based on this situation, the Wi-Fi Alliance has proposed a new generation of Wi-Fi protocol, IEEE 802.11ax, whose primary purpose is to solve the problem of network capacity and improve network efficiency.

One of the most important measures for 802.11ax to improve efficiency is the adoption of Orthogonal Frequency Division Multiple Access (OFDMA) technology. OFDMA technology further divides the channel into smaller resource units (RU), and an Access Point (AP) allocates data transmission between different terminals to different RUs, so that the AP can communicate with multiple devices simultaneously, thus improving the transmission efficiency of wireless networks. Trigger frame, a new control frame introduced in 802.11ax, enables efficient OFDMA communication among 802.11ax supported devices in the network and enhances network efficiency. However, the powerful control ability and lack of effective protection of the trigger frame or other similar control frame make them prone to become a breakthrough point for hackers to compromise the network. Therefore, how to effectively protect trigger frames or control frames so as to ensure the security of a network is the focus and difficulty of the research in the field of wireless communication.

### SUMMARY OF THE INVENTION

In order to solve the above problems, the present disclosure provides a control frame processing method, applied to a wireless communication station, comprising:
receiving a control frame transmitted by an access point, where the control frame includes a check field, and the check field includes a random value and a message integrity check (MIC) check value;
parsing the received control frame to extract the random value and the MIC check value therein;
decrypting the random value and the MIC check value by using a data key from the access point to obtain an original plaintext of the random value and an original plaintext of the MIC check value;
calculating a local MIC check value by using a MIC key from the access point, a non-check field in the control frame, and the random value;
determining whether the original plaintext of the MIC check value is consistent with the local MIC check value, and in response to that the original plaintext of the MIC check value is consistent with the local MIC check value, performing a corresponding control operation according to the control frame.

Optionally, after determining whether the original plaintext of the MIC check value is consistent with the local MIC check value, the method further includes:
in response to that the original plaintext of the MIC check value is inconsistent with the local MIC check value, discarding the control frame.

Optionally, before parsing the received control frame to extract the random value and the MIC check value therein, the method further includes:
determining whether the control frame contains a valid check field;
in response to that the control frame contains a valid check field, performing a subsequent operation of parsing the received control frame to extract the random value and the MIC check value therein; in response to that the control frame does not contain a valid check field, discarding the control frame.

Optionally, before parsing the received control frame to extract the random value and the MIC check value therein, the method further includes:
determining whether the station is associated with the access point;
in response to that the station is associated with the access point, performing a subsequent operation of parsing the received control frame to extract the random value and the MIC check value therein; in response to that the station is not associated with the access point, performing a corresponding control operation according to the control frame.

Optionally, after obtaining the original plaintext of the random value and the original plaintext of the MIC check value, the method further includes:
determining whether the decoded original plaintext of the random value satisfies a condition of being monotonically increasing or monotonically decreasing;
in response to that the decoded original plaintext of the random value satisfies the condition of being monotonically increasing or monotonically decreasing, performing a subsequent operation of calculating the local MIC check value by using the received control frame; in response to that the decoded original plaintext of the random value does not satisfy the condition of being monotonically increasing or monotonically decreasing, discarding the control frame.

Optionally, the control frame is a trigger frame for resource allocation for uplink OFDMA transmission.

Optionally, the MIC key is a MIC key transmitted from the access point to the station by multicast.

The present disclosure further provides a station, where the station includes a processor and a memory; wherein the memory is configured to store program instructions;
the processor is configured to perform operations of any one of the control frame processing methods described above according to the program instructions.

The present disclosure further provides a computer-readable storage medium, wherein the computer-readable storage medium stores program instructions, and the program instructions, when being executed, perform operations of any one of the control frame processing methods described above.

The present disclosure further provides a control frame generating method, which is applied to an access point for wireless communication, and includes:
generating a random value;
calculating a MIC check value by using a non-check field of the control frame, the random value, and a MIC key transmitted to the station;
encrypting the random value and the calculated MIC check value by using a data key to obtain a ciphertext of the random value and a ciphertext of the MIC check value;
adding the ciphertext of the random value and the ciphertext of the MIC check value as a check field to the control frame;
transmitting the control frame to the station.

Optionally, the check field includes: a control frame check field identifier, a data type, a data length, and numerical information; wherein, the control frame check field identifier is configured to identify whether the current field is a check field; the data type is configured to identify the type of the numerical information as a random value type or a MIC check value type; the data length is configured to identify the length of the numerical information; and the numerical information is configured to indicate a corresponding random value when the data type is identified as the random value type, or to indicate a corresponding MIC check value when the data type is identified as the MIC check value.

Optionally, the random value is generated in a monotonically increasing or monotonically decreasing manner.

The present disclosure further provides an access point, where the access point includes a processor and a memory; wherein the memory is configured to store program instructions;
the processor is configured to perform operations of any one of the control frame generating methods described above according to the program instructions.

The present disclosure further provides a computer-readable storage medium, wherein the computer-readable storage medium stores program instructions, and the program instructions, when being executed, perform operations of any one of the control frame generating methods described above.

In the provided control frame processing method applied to a station of wireless communication, as provided in the present application, a control frame transmitted by an access point is received, wherein the control frame includes a check field, and the check field includes a random value and a MIC check value; the control frame is parsed to extract the random value and the MIC check value therein; the random value and the MIC check value are decrypted by using a data key from the access point to obtain an original plaintext of the random value and an original plaintext of the MIC check value; the local MIC check value is calculated by using the MIC key from the access point, a non-check field in the control frame and the random value; whether the original plaintext of the MIC check value is consistent with the local MIC check value is determined, and in response to that the original plaintext of the MIC check value is consistent with the local MIC check value, a corresponding control operation is performed according to the control frame. The control frame processing method provided in the present application can effectively protect the control frame, prevent hackers from using the control frame to carry out wireless network attacks, and ensure the security of the network. This application utilizes the reserved field in the control frame to perform the encryption operation, and only encrypts the check information instead of encrypting the data part of the frame body. Therefore, even if one of the communicating parties does not support the encryption method of the present application, the normal communication between the two parties will not be affected, and the security is improved while compatibility is also taken into account, making it more scalable. In addition, since the data part of the frame body is not encrypted in this application, and the MIC check value is obtained based on the data of the frame body and the MIC key, if no random number is added, an attacker may obtain the MIC check value from the data of the frame body and the MIC check value. Therefore, in this solution, the security of the network is further improved by the approach of adding a random number.

In addition, the present application further provides a station, a control frame generating method, an access point, and a computer-readable storage medium having at least the above-mentioned technical advantages.

### BRIEF DESCRIPTION OF THE DRAWINGS

In the following, the present application will be further explained on the basis of embodiments with reference to the attached drawings.

FIG. 1 schematically illustrates a schematic diagram of an uplink OFDMA transmission based on a trigger frame;

FIG. 2 schematically illustrates a flow chart of a specific implementation of a control frame processing method provided by the present application;

FIG. 3 schematically illustrates a schematic diagram of a format of a trigger frame;

FIG. 4 schematically illustrates a flow chart of another specific embodiment of the control frame processing method provided by the present application;

FIG. 5 schematically illustrates a structural block diagram of a specific embodiment of a control frame processing apparatus provided by the present application;

FIG. 6 schematically illustrates a structural block diagram of a specific embodiment of a station provided by the present application;

FIG. 7 schematically illustrates a flow chart of a specific embodiment of a control frame generating method provided by the present application;

FIG. 8 schematically illustrates a structural block diagram of a specific embodiment of a control frame generating apparatus provided by the present application;

FIG. 9 schematically illustrates a structural block diagram of an access point provided by the present application.

### DETAILED DESCRIPTION OF THE PREFERRED EMBODIMENTS

The method and apparatus of the present application will be described in detail below with reference to the accompanying drawings and specific embodiments. It should be understood that the embodiments shown in the accompanying drawings and described hereinafter are merely illustrative and not intended to limit the disclosure.

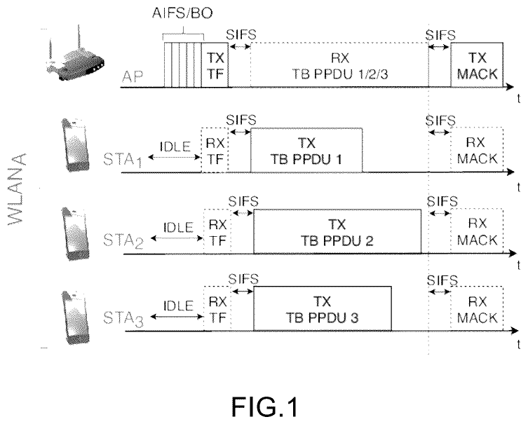

Referring to a schematic diagram of an uplink OFDMA transmission based on a trigger frame in FIG. 1, an access point (AP) transmits a trigger frame to inform all stations (STAs) of the Association ID (AID), RU location, transmission time, and transmission power and other information of the station that needs to send the packet. The station that receives the trigger frame compares its own AID with the AID in the trigger frame, and if it recognizes that its own AID is the same as the AID in the trigger frame, it will transmit TB PPDU according to the specified parameters after a time of SIFS after receiving the trigger frame. After receiving the trigger frame, the access point uses the MU-STA BA frame to reply to all stations.

The trigger frame is the key to the high-efficiency transmission of the 802.11ax protocol. As a control frame, the trigger frame is not protected by any security measure. Moreover, the 802.11ax protocol stipulates that the trigger frame can be sent according to any physical frame format other than 802.11b, so the cost of using the trigger frame to carry out attacks such as denial of service (DoS) is very low. Hackers who use trigger frames to attack can make any one or more stations send packets at a specified RU with a specified power, so that the attacked device cannot send and receive packets normally. For example, a hacker can send a trigger frame every 10 ms, allowing the attacked device to send a 5 ms TB PPDU packet on a 26tone RU with a very small transmission power. This kind of attack, while paralyzing the attacked device, will hardly affect the normal communication of other devices in the network.

As a newly introduced control frame in the 802.11ax protocol, because the protocol stipulates unified security measures for protection, the direct adoption of encryption in management frames will cause incompatibility among devices. In view of this, the present application aims to solve the problem that the newly introduced trigger frame lacks an effective protection mechanism, and prevent hackers from using the trigger frame to attack wireless network, to ensure the security of the 802.11ax network.

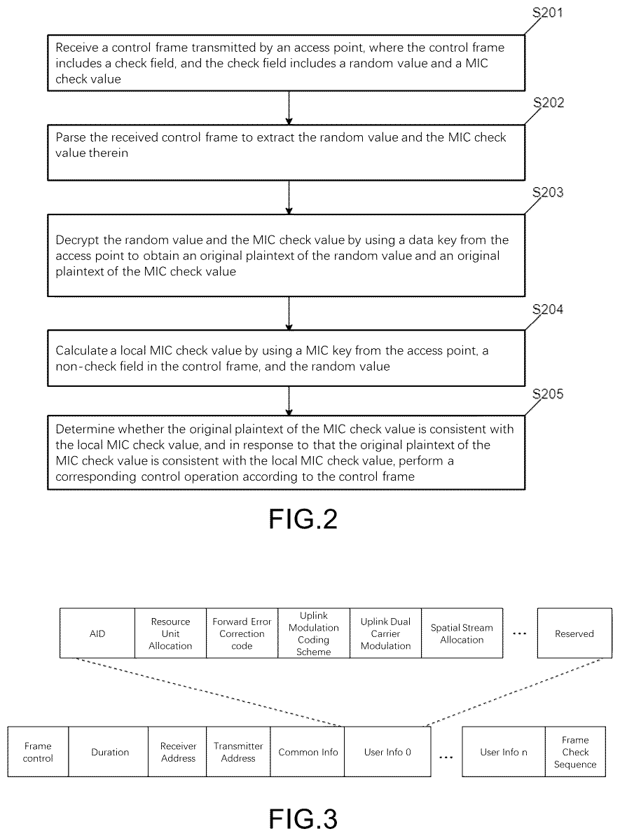

FIG. 2 illustrates a flow chart of a specific implementation of the control frame processing method provided by the present application. In this embodiment, the method is applied to a station for wireless communication, which specifically includes following steps.

At S201: a control frame transmitted by an access point is received, where the control frame includes a check field, and the check field includes a random value and a MIC check value.

In this embodiment of the present application, a check field is added to the control frame, and the check field includes a random value R and a MIC (Message Integrity Code) check value. As a specific implementation, the check field may include: a control frame check field identifier (AID), a data type (info_type), a data length (info_len), and numerical information (info_data). Herein, the control frame check field identifier (AID) is configured to identify whether the current field is a check field; the data type (info_type) is configured to identify the type of the numerical information as a random value type or a MIC check value type; the data length (info_len) is configured to identify the length of the numerical information; and the numerical information (info_data) is configured to indicate a corresponding random value when the data type is identified as a random value type, or to indicate a corresponding MIC check value when the data type is identified as a MIC check value.

The following describes a specific form of adding a check field. The control frame is taken as an example of a trigger frame, with reference to a schematic diagram of the format of the trigger frame in FIG. 3. The trigger frame includes a MAC header, a common information (common info) field, and multiple user information (user info) fields. A basic length of the user information (user info) field is 40 bits, and there will be several additional information of the trigger frame according to different subdivision types of the trigger frame. Each user information (user info) field includes a 12-bit AID and a series of control information. In the embodiment of the present application, a number of user information (user info) fields of AID are added after the last valid user information (user info) field of the trigger frame for transmission of the check field. The structure of the newly added user information (user info) check field is shown in Table 1.

TABLE 1

| Position | Bit 0:Bit 11 | Bit 12:Bit 13 | Bit 14:Bit 15 | Bit 15:Bit 39 | Other |
|---|---|---|---|---|---|
| Content | 4094 | info_type | info_len | info_data | 0 |

In this embodiment, AID=4094 is the trigger frame check field identifier. It is understood that it is only a specific example, and in practice, any AID reserved by the trigger frame can be used and is not limited to this specific form. When info_type is 0, it indicates that the type of subsequent info_data is a random value R, and when info_type is 1, it indicates that the type of subsequent info_data is a MIC check value. The info_len indicates the length of valid data in the info_data in bytes. The info_data is the specific random value or MIC check value that is carried. The access point (AP) can transmit a random value or a MIC check value of any length by carrying a plurality of user information (user info) as described above in the transmitted control frame.

At S202: the received control frame is parsed to extract the random value and the MIC check value therein.

After receiving the control frame transmitted by the access point, the station parses the control frame to extract the random value R_{rx_encry} and the MIC check value MIC_{rx_encry} carried in the control frame. As a specific embodiment, the station, after recognizing the AID=4094 tag, can extract the random value R_{rx_encry} and the MIC check value MIC_{rx_encry} therefrom.

At S203: the random value and the MIC check value are decrypted by using a data key from the access point, to obtain an original plaintext of the random value and an original plaintext of the MIC check value.

The random value R_{rx_encry} and the MIC check value MIC_{rx_encry} are decrypted by using a local data key of the station which is from the access point, to obtain an original plaintext of the random value (Rᵣₓ) and the original plaintext of the MIC check value (MICᵣₓ). It can be understood that, the decryption method can use a symmetric algorithm such as the AES algorithm or an asymmetric algorithm, which is not limited here.

At S204: a local MIC check value is calculated by using a MIC key from the access point, a non-check field in the control frame, and the random value.

The local MIC check value MIC_{local} is calculated by using the MIC key from the access point, the non-check field in the control frame, and the random value. The MIC key is configured to calculate the MIC check value, and the MIC key may be a MIC key transmitted from the access point to the station by multicast. In this application, the control frame is a variable-length control frame, which can support the storage of a check field. The control frame can be divided into a check field and a non-check field. As a specific embodiment, the control frame can be a trigger frame.

At S205: whether the original plaintext of the MIC check value is consistent with the local MIC check value is determined, and in response to that the original plaintext of the MIC check value is consistent with the local MIC check value, performing a corresponding control operation according to the control frame.

MIC_{local} is compared with MICᵣₓ, and if MIC_{local} is consistent with MICᵣₓ, respond to the control frame according to the 802.11ax protocol, and perform corresponding control operations.

On the basis of the above embodiments, the control frame processing method provided in the present application may further include: after determining whether the original plaintext of the MIC check value is consistent with the local MIC check value, further including: discarding the control frame in response to that the original plaintext of the MIC check value is inconsistent with the local MIC check value. That is, when the comparison between MIC_{local} and MICᵣₓ is inconsistent, the control frame is discarded.

The control frame processing method provided in the present application can effectively protect the control frame, prevent hackers from using the control frame to carry out wireless network attacks, and ensure the security of the network. This application utilizes the reserved field in the control frame to perform the encryption operation, and only encrypts the check information instead of encrypting the data part of the frame body. Therefore, even if one of the communicating parties does not support the encryption method of the present application, the normal communication between the two parties will not be affected, and the security is improved while compatibility is also taken into account, making it more scalable. In addition, since the data part of the frame body is not encrypted in this application, and the MIC check value is obtained based on the data of the frame body and the MIC key, if no random number is added, an attacker may obtain the MIC check value from the data of the frame body and the MIC check value. Therefore, in this solution, the security of the network is further improved by the approach of adding a random number.

Further, the random value Rᵣₓ obtained this time can also be recorded for the next check process. Specifically, after obtaining the original plaintext of the random value and the original plaintext of the MIC check value, it can be determined whether the original plaintext of the decoded random value satisfies the condition of being monotonically increasing or monotonically decreasing, and in the case that the condition of being monotonically increasing or monotonically decreasing is satisfied, the subsequent check operation is performed. In the case that the condition of being monotonically increasing or monotonically decreasing is not satisfied, the control frame is discarded. By setting the check condition, the security of the network is further ensured.

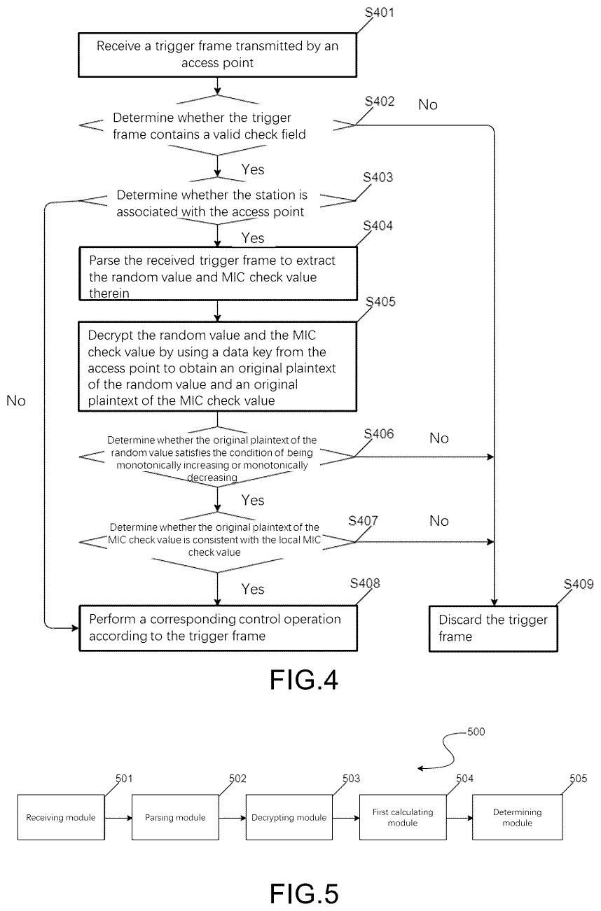

FIG. 4 shows the flow chart of another specific embodiment of the control frame processing method provided in the present application. In this embodiment, the control frame is taken as an example of the trigger frame, and the operation process of determining whether the control frame contains a valid check field, determining whether the station is associated with the access point, and determining whether the original plaintext of the random value satisfies the condition of being monotonically increasing or monotonically decreasing is added. Referring to FIG. 4, the method specifically includes following steps.

At S401: a trigger frame transmitted by an access point is received, where the trigger frame includes a check field, and the check field includes a random value and a MIC check value.

At S402: whether the trigger frame contains a valid check field is determined; in response to that the trigger frame contains a valid check field, proceed to S403; in response to that the trigger frame does not contain a valid check field, proceed to S409.

At S403: whether the station is associated with the access point is determined; in response to that the station is associated with the access point, proceed to S404; in response to that the station is not associated with the access point, proceed to S408.

At S404: the received trigger frame is parsed to extract the random value and MIC check value therein.

At S405: the random value and the MIC check value are decrypted by using a data key from the access point to obtain an original plaintext of the random value and an original plaintext of the MIC check value.

At S406: whether the decoded original plaintext of the random value satisfies the condition of being monotonically increasing or monotonically decreasing is determined; in response to that the decoded original plaintext of the random value satisfies the condition, proceed to S407; in response to that the decoded original plaintext of the random value does not satisfy the condition, proceed to S409.

At S407: the local MIC check value is calculated by using the MIC key from the access point, the non-check field in the trigger frame, and the random value, and whether the original plaintext of the MIC check value is consistent with the local MIC check value is determined; and in response to that the original plaintext of the MIC check value is consistent with the local MIC check value, proceed to S408; in response to that the original plaintext of the MIC check value is not consistent with the local MIC check value, proceed to S409.

At S408: a corresponding control operation is performed according to the trigger frame.

At S409: the trigger frame is discarded.

As specified by the 802.11ax protocol, when the station is not connected to the access point, it can also use the information in the user field with AID=2046 for the transmission of TB PPDU. In this scenario, since the station has not yet been assigned a multicast key, no check is performed on the trigger frame, and the trigger frame is transmitted in accordance with the 802.11ax protocol.

By determining whether the station has been associated with the access point, it is determined whether the station and the access point have established a connection. In the case that the station is associated or connected with the access point, the station receives the data key and the MIC key from the access point.

If the station that receives the trigger frame has obtained the multicast key, R_{rx_encry} and MIC_{rx_encry} are extracted upon receiving the trigger frame according to the AID=4094 tag. Then, these two parts are decrypted using the local multicast data key to obtain the original plaintext Rᵣₓ and MICᵣₓ. If the original plaintext of the decoded random value should satisfy the condition of being monotonically increasing, then if the random number Rᵣₓ received this time is smaller than the one parsed last time, it is considered that this trigger frame should not be trusted, and the station does not respond to the trigger frame. If the original plaintext of the decoded random value should satisfy the condition of being monotonically decreasing, then if the random number Rix received this time is larger than the one parsed last time, it is considered that this trigger frame should not be trusted, and the station does not respond to the trigger frame. Otherwise, the MIC_{local} is calculated using the local MIC key by the decryption algorithm together with the decrypted Rᵣₓ, starting from the MAC header of the received trigger frame to the last valid user info, i.e., the user info that does not include AID 4094. Finally, MIC_{local} and MICᵣₓ are compared; if MIC_{local} and MICᵣₓ are inconsistent, the trigger frame is discarded. Otherwise, the trigger frame is responded according to the 802.11ax protocol, and the random value Rᵣₓ obtained this time is recorded for the next check.

As a specific embodiment, the decryption method can be AES-CBC.

This embodiment provides a trigger frame protection scheme that takes into account both compatibility and security. The encryption operation is performed using the reserved field in the trigger frame, and the check information is encrypted, instead of the data part of the frame body being encrypted. Therefore, even if one of the communicating parties does not support the encryption method of the present application, the normal communication between the two parties will not be affected, and the security is improved while compatibility is also taken into account, making it more scalable. In addition, since the data part of the frame body is not encrypted in this application, and the MIC check value is obtained based on the data of the frame body and the MIC key, if no random number is added, an attacker may obtain the MIC check value from the data of the frame body and the MIC check value. Therefore, in this solution, the security of the network is further improved by the approach of adding a random number to determine its monotonous increase or decrease.

In addition, the present application further provides a control frame processing apparatus, and the control frame processing apparatus is applied to a station for wireless communication. As shown in FIG. 5, a structural block diagram of a specific embodiment of a control frame processing apparatus 500 is provided in this application, and the apparatus specifically includes a receiving module 501, a parsing module 502, a decrypting module 503, a first calculating module 504 and a determining module 505.

The receiving module 501 is configured to receive a control frame transmitted by an access point, where the control frame includes a check field, and the check field includes a random value and a MIC check value.

The parsing module 502 is configured to parse the received control frame to extract the random value and MIC check value therein.

The decrypting module 503 is configured to decrypt the random value and the MIC check value by using a data key from the access point to obtain an original plaintext of the random value and an original plaintext of the MIC check value.

The first calculating module 504 is configured to calculate a local MIC check value by using a MIC key from the access point, a non-check field in the control frame, and the random value.

The determining module 505 is configured to determine whether the original plaintext of the MIC check value is consistent with the local MIC check value, and in response to that the original plaintext of the MIC check value is consistent with the local MIC check value, a corresponding control operation is performed according to the control frame.

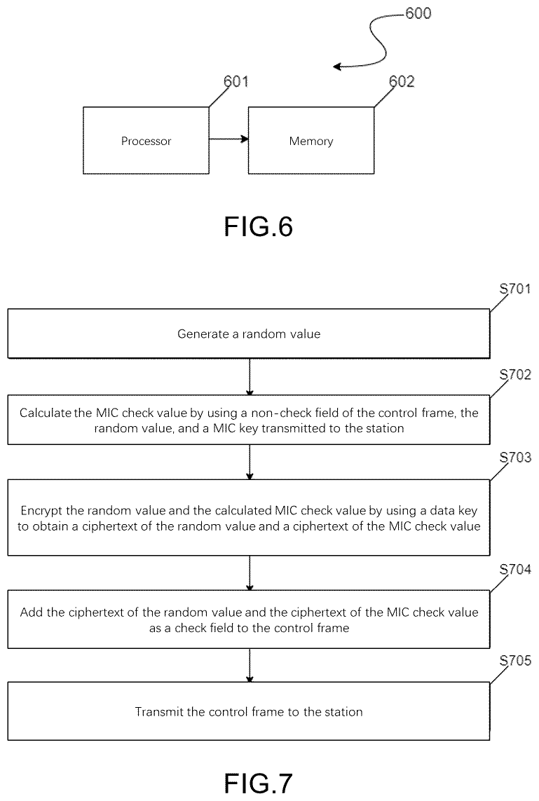

In addition, the present application also provides a station 600, as shown in a structural block diagram of a specific embodiment of the station of FIG. 6, the station 600 includes a processor 601 and a memory 602. Wherein, the memory is configured to store program instructions; the processor is configured to perform operations of any one of the control frame processing methods described above according to the program instructions.

In addition, the present disclosure further provides a computer-readable storage medium, wherein the computer-readable storage medium stores program instructions, and the program instructions, when being executed, perform operations of any one of the control frame processing methods described above.

It can be understood that the control frame processing apparatus, the station, and the computer-readable storage medium provided in the present application correspond to the control frame processing method described above, of which the specific embodiments can be referred to the content of the above method parts, and will not be repeated here.

In addition, the present application further provides a control frame generating method, which is applied to an access point for wireless communication, as shown in a flow chart of the control frame generating method of a specific embodiment provided in the present disclosure in FIG. 7, the method including following steps.

At S701: a random value is generated.

The access point generates a random value R. For example, a 128-bit random value R may be generated. The 128 bits, of course, is only a specific example here, and does not constitute a limitation. The random value R generated by the access point can satisfy the condition of being monotonically increasing or monotonically decreasing. After receiving the control frame, the station parses a random value from the control frame, and can determine whether the random value satisfies the condition of being monotonically increasing or monotonically decreasing compared with the previously parsed data. If the condition of being monotonically increasing or monotonically decreasing is not satisfied, the control frame is discarded, so as to avoid replay attacks.

At S702: the MIC check value is calculated by using a non-check field of the control frame, the random value, and a MIC key sent to the station.

All the data starting from the MAC header to the last valid user info in the control frame and the random value R are calculated according to the non-check field of the control frame, the random value and the MIC key transmitted to the station to obtain the MIC check value. The MIC key may be the MIC key obtained when the station is connected to the access point. Specifically, AES-CBC can be used to calculate the MIC check value to ensure the integrity of the control frame.

At S703: the random value and the calculated MIC check value are encrypted by using a data key to obtain a ciphertext of the random value and a ciphertext of the MIC check value.

The generated random value R and the calculated MIC check value are encrypted using an encryption algorithm based on the multicast frame data key to obtain the ciphertext R* of the random value and the ciphertext MIC* of the MIC check value. The encryption algorithm can use a symmetric algorithm such as the AES algorithm, and of course an asymmetric algorithm can also be used.

At S704: the ciphertext of the random value and the ciphertext of the MIC check value as a check field are added to the control frame.

As a specific embodiment, the check field can include: a control frame check field identifier, a data type, a data length, and numerical information. The control frame check field identifier is configured to identify whether the current field is a check field; the data type is configured to identify the type of the numerical information as a random value type or a MIC check value type; the data length is configured to identify the length of the numerical information; and the numerical information is configured to indicate a corresponding random value when the data type is identified as the random value type, or to indicate a corresponding MIC check value when the data type is identified as the MIC check value.

Taking the trigger frame as an example, the schematic diagram of the generating process of the check field of the control frame is shown in FIG. 7. The MIC check value operation is performed based on the original control frame and the random number to obtain the integrity check information MIC of the control frame. The random number and the MIC check value are then encrypted, and the ciphertext R* of the random value and the ciphertext MIC* of the MIC check value are split and then added to the control frame according to the above method of adding a check field. The splitting process may be done by transmitting the low bits first and then the high bits, or of course the high bits can be transmitted first and then the low bits, both of which will not affect the implementation of this application.

At S705: the control frame is transmitted to the station.

The access point transmits the control frame to the station, and after receiving the control frame, the station performs the operations of the above control frame processing method.

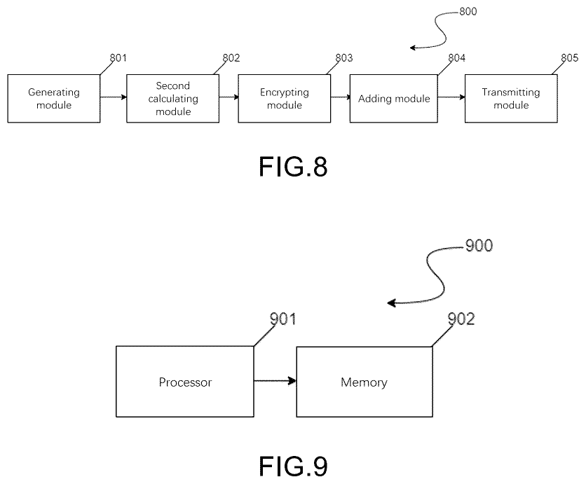

In addition, the present application further provides a control frame generating apparatus, which is applied to an access point for wireless communication, as shown in a structural block diagram of a specific embodiment of the control frame generating apparatus 800 provided in the present disclosure in FIG. 8, the apparatus specifically including a generating module 801, a second calculating module 802, an encrypting module 803, an adding module 804 and a transmitting module 805.

The generating module 801 is configured to generate a random value.

The second calculating module 802 is configured to calculate the MIC check value by using a non-check field of the control frame, the random value and a MIC key transmitted to the station.

The encrypting module 803 is configured to encrypt the random value and the calculated MIC check value by using a data key to obtain a ciphertext of the random value and a ciphertext of the MIC check value.

The adding module 804 is configured to add the ciphertext of the random value and the ciphertext of the MIC check value as a check field to the control frame.

The transmitting module 805 is configured to transmit the control frame to the station.

In addition, the present application further provides an access point 900, as shown in the structural block diagram of the access point in FIG. 9. The access point 900 includes a processor 901 and a memory 902; wherein, the memory 902 is configured to store program instructions; and the processor 901 is configured to perform the operations of any one of the control frame generating method described above according to the program instructions.

In addition, the present disclosure further provides a computer-readable storage medium, wherein the computer-readable storage medium stores program instructions, and the program instructions, when being executed, perform operations of any one of the control frame generating methods described above.

It can be understood that the control frame generating apparatus, the access point, and the computer-readable storage medium provided in the present application correspond to the above-mentioned control frame generating method, and the specific embodiments of which can be referred to the content of the above-mentioned method, and will not be repeated here.

The technical solution of the present application can be applied in an IEEE 802.11ax wireless local area network, where the network includes one or more access points (AP) and one or more stations (STA).

Wherein, the station may be an apparatus with wireless communication function, such as a user equipment, an access terminal, a remote terminal, a user terminal, a mobile device, and can also be a cellular phone, a handheld device with wireless communication function, a vehicle-mounted device, a wearable device, etc., which is not limited by this embodiment of the present application.

The access point may be any kind of apparatus that has a wireless transceiver function and communicates with a station. The apparatus includes but is not limited to an evolved Node B, a wireless network controller, a Node B, a base station controller, etc., and can also be an antenna panel or a group of antenna panels of a base station in a 5G or 5G system, or can also be a baseband unit or a distributed unit, etc., which is not limited herein.

The application can effectively protect the control frame, prevent hackers from using the control frame to carry out wireless network attacks, and ensure the security of the network. This application utilizes the reserved field in the control frame to perform the encryption operation, and encrypts the check information instead of encrypting the data part of the frame body. Therefore, even if one of the communicating parties does not support the encryption method of the present application, the normal communication between the two parties will not be affected, and the security is improved while compatibility is also taken into account, making it more scalable. In addition, since the data part of the frame body is not encrypted in this application, and the MIC check value is obtained based on the data of the frame body and the MIC key, if no random number is added, an attacker may obtain the MIC check value from the data of the frame body and the MIC check value. Therefore, in this solution, the security of the network is further improved by the approach of adding a random number.

While various embodiments of various aspects of the invention have been described for the purpose of the disclosure, it shall not be understood that the teaching of the disclosure is limited to these embodiments. The features disclosed in a specific embodiment are therefore not limited to that embodiment, but may be combined with the features disclosed in different embodiments. For example, one or more features and/or operations of the method according to the present application described in one embodiment may also be applied individually, in combination or as a whole in another embodiment. It can be understood by those skilled in the art that more optional embodiments and variations are possible, and that various changes and modifications may be made to the system described above, without departing from the scope defined by the claims of the present disclosure.

1. A control frame processing method, applied to a station for wireless communication, the method comprising:
receiving a control frame transmitted by an access point, the control frame comprising a check field, and the check field comprising a random value and a MIC check value;
analyzing the received control frame to extract the random value and the MIC check value;
decrypting the random value and the MIC check value by using a data key from the access point to obtain the original plaintext of the random value and the original plaintext of the MIC check value;
calculating a local MIC check value by using a MIC key from the access point, a non-check field in the control frame, and the random value;
determining whether the original plaintext of the MIC check value is consistent with the local MIC check value, and in response to that the original plaintext of the MIC check value is consistent with the local MIC check value, performing a corresponding control operation according to the control frame.

2. The control frame processing method according to claim 1, wherein, after the determining whether the original plaintext of the MIC check value is consistent with the local MIC check value, the method further comprises:
in response to that the original plaintext of the MIC check value is inconsistent with the local MIC check value, discarding the control frame.

3. The control frame processing method according to claim 1, wherein, before parsing the received control frame to extract the random value and the MIC check value, the method further comprises:
determining whether the control frame contains a valid check field;
in response to that the control frame contains a valid check field, performing subsequent operations of parsing the received control frame to extract the random value and the MIC check value.

4. The control frame processing method according to claim 1, wherein, before parsing the received control frame to extract the random value and the MIC check value, the method further comprises:
determining whether the station is associated with the access point;
in response to that the station is associated with the access point, performing subsequent operations of parsing the received control frame to extract the random value and the MIC check value.

5. The control frame processing method according to claim 1, wherein, after obtaining the original plaintext of the random value and the original plaintext of the MIC check value, the method further comprises:
determining whether the decoded original plaintext of the random value satisfies a condition of being monotonically increasing or monotonically decreasing;
in response to that the decoded original plaintext of the random value satisfies the condition of being monotonically increasing or monotonically decreasing, performing a subsequent operation of calculating the local MIC check value by using the received control frame.

6. The control frame processing method according to claim 5, wherein the control frame is a trigger frame configured for resource allocation for uplink OFDMA transmissions.

7. The control frame processing method according to claim 5, wherein the MIC key is a MIC key transmitted from the access point to the station by multicast.

8. A station, comprising a processor and a memory; the memory being configured to store program instructions; and,
the processor being configured to perform operations of a control frame processing method according to the program instructions, the method comprising:
receiving a control frame transmitted by an access point, the control frame comprising a check field, and the check field comprising a random value and a MIC check value;
analyzing the received control frame to extract the random value and the MIC check value;
decrypting the random value and the MIC check value by using a data key from the access point to obtain the original plaintext of the random value and the original plaintext of the MIC check value;
calculating a local MIC check value by using a MIC key from the access point, a non-check field in the control frame, and the random value;
determining whether the original plaintext of the MIC check value is consistent with the local MIC check value, and in response to that the original plaintext of the MIC check value is consistent with the local MIC check value, performing a corresponding control operation according to the control frame.

9. (canceled)

10. A control frame generating method, applied to an access point for wireless communication, the method comprising:
generating a random value;
calculating a MIC check value by using a non-check field of the control frame, the random value, and a MIC key transmitted to the station;
encrypting the random value and the calculated MIC check value by using a data key to obtain a ciphertext of the random value and a ciphertext of the MIC check value;
adding the ciphertext of the random value and the ciphertext of the MIC check value as a check field to the control frame;
transmitting the control frame to the station.

11. The control frame generating method according to claim 10, wherein, the check field comprises: a control frame check field identifier, a data type, a data length, and numerical information; wherein,
the control frame check field identifier is configured to identify whether the current field is a check field;
the data type is configured to identify a type of the numerical information as a random value type or a MIC check value type;
the data length is configured to identify a length of the numerical information; and
the numerical information is configured to indicate a corresponding random value when the data type is identified as the random value type, or to indicate a corresponding MIC check value when the data type is identified as the MIC check value.

12. The control frame generating method according to claim 10, wherein the random value is generated in a manner of monotonically increasing or monotonically decreasing.

13. (canceled)

14. (canceled)

15. The control frame processing method according to claim 3, further comprising: in response to that the control frame does not contain a valid check field, discarding the control frame.

16. The control frame processing method according to claim 4, further comprising: in response to that the station is not associated with the access point, performing a corresponding control operation according to the control frame.

17. The control frame processing method according to claim 5, further comprising: in response to that the decoded original plaintext of the random value does not satisfy the condition of being monotonically increasing or monotonically decreasing, discarding the control frame.

18. The control frame generating method according to claim 11, wherein the random value is generated in a manner of monotonically increasing or monotonically decreasing.
